(19) United States
(12) Patent Application Publication
(10) Pub. No.: US 2026/0355692 A1
(43) Pub. Date: Nov. 12, 2026

(54) Directing Fluid Flow in an Electrodialysis Stack

(71) Applicant: Captura Corp., Pasadena, CA (US)

(72) Inventors: Michael Lichterman, Pasadena, CA (US); Guanyu Ma, Pasadena, CA (US); Chengxiang Xiang, San Marino, CA (US)

(73) Assignee: Captura Corp., Pasadena, CA (US)

(21) Appl. No.: 19/204,251

(22) Filed: May 9, 2025

(51) Int. Cl. B01D 61/50; B01D 61/44; C02F 1/469

(52) U.S. Cl. CPC B01D 61/50; B01D 61/445; C02F 1/4693; B01D 2313/086; B01D 2313/14; B01D 2325/04; B01D 2325/42; C02F 2201/4611; C02F 2201/46115

(57) ABSTRACT

Aspects of the disclosure relate to an electrodialysis stack that includes a plurality of layers disposed between an anode and a cathode. The plurality of layers includes a plurality of ion exchange membranes. The plurality of layers also includes a plurality of spacers. The plurality of spacers include a first spacer that contacts a first surface of the first ion exchange membrane. The first spacer includes interior boundaries that define a first flow path across the first surface of the first ion exchange membrane. The plurality of spacers includes a second spacer that contacts the second surface of the first ion exchange membrane and includes interior boundaries that define a second flow path across the second surface of the first ion exchange membrane.

### BACKGROUND

The following description relates to directing fluid flow in an electrodialysis system.

Electrodialysis is an electrochemical process where salt ions are transported between solutions through an ion exchange membrane while being exposed to an electrical potential difference. Electrodialysis is typically utilized for deionization of aqueous solutions. Applications include seawater desalination, drinking water production, water reuse, and acid/base generation from salts.

### DESCRIPTION OF DRAWINGS

FIG. 1A is an illustration of velocity contours for an open flow path.

FIG. 1B is an illustration of pressure contours for the flow path of FIG. 1A.

FIG. 1C is an illustration of velocity contours for a squared flow path.

FIG. 1D is an illustration of pressure contours for the flow path of FIG. 1C.

FIG. 2 is a schematic diagram illustrating ion exchange membranes, water dissociation, and ion transport in an example bipolar electrodialysis stack.

FIG. 3 is a schematic diagram illustrating a plurality of layers and flow paths in an example electrodialysis stack.

FIG. 4A is an illustration of velocity contours in an example flow path.

FIG. 4B is an illustration of pressure contours in the flow path of FIG. 4A.

FIG. 4C is a detailed view of a flow path of FIG. 4A.

FIG. 4D is a plan view illustrating multiple stacked spacers of an example electrodialysis system.

FIG. 5 is a flow diagram illustrating an example electrodialysis process.

### DETAILED DESCRIPTION

Certain aspects of the disclosure relate to electrodialysis systems and methods. In some implementations, electrodialysis systems are used for separation, synthesis, purification or other processing of fluid mixtures through the selective transfer of mass using an electrodialysis stack. In some aspects of what is described, internal manifold designs of a fluid separation membrane apparatus can improve the way fluid streams enter, exit and move through the chambers in an electrodialysis stack. In some implementations, features of an electrodialysis stack can provide a number of advantages. For example, internal flow manifolds can be configured to reduce leakage between streams while simultaneously enhancing flow regulation and pressure management, thereby enabling the use of thinner and more efficient ion exchange membranes.

In some aspects, electrodialysis systems perform fluid separation and purification using selective ion transfer through ion exchange membranes. In some electrodialysis systems, stacked cell designs include thin compartments or chambers formed between terminal end plates. These chambers are typically separated by ion exchange membranes or other structural elements, and are formed within spacers that may take the shape of open frames. In any membrane separation apparatus—whether applied in mass diffusion, gaseous diffusion (molecular effusion), electrodialysis, piezodialysis, thermodialysis, thermoosmosis, electroosmosis, dialysis, osmosis, ultrafiltration (hyperfiltration), reverse osmosis (piezoosmosis), membrane permeation (pervaporation), or similar processes—introducing and extracting fluids from each compartment presents challenges due to narrow spacing between adjacent barriers. The fluid streams flow in generally parallel planes within the chambers, with adjacent streams separated by an ion exchange membrane, film, or another type of thin barrier. One aspect of effective separation is ensuring that fluid components selectively pass through the relevant chamber while preventing cross-leakage that could degrade performance.

In some electrodialysis systems, fluid introduction and removal is managed using internal conduits or manifolds, which are formed by aligning or registering holes or apertures in the gasketing regions of the ion exchange membranes, spacers, and other stack elements. Fluid inlet and outlet manifold holes in each spacer can be connected to a fluid flow path within the spacer by a channel or other means, such as by removing an interior portion of the spacer frame material. These entrance and exit channels create passageways linking the flow path to the fluid-holding compartment. In some implementations, manifold apertures may be positioned in marginal gasketing areas or more centrally within the gasketing region. The sets of inlet and outlet manifold holes may ensure that various fluids circulating through the electrodialysis stack remain hydraulically isolated from one another.

In some electrodialysis systems, ion exchange membranes may tend to deform under differential pressure conditions. This deformation, particularly in areas adjacent to the entrance and exit channels, can lead to unintended cross-leakage between fluid streams. Under pressure, the ion exchange membrane can bow or deflect into the connecting channels, increasing the likelihood of one fluid stream infiltrating another. This is particularly pronounced in membrane processes involving substantial differential pressures (for example, 5 psi or more), where fluids from higher-pressure compartments may leak into adjacent lower-pressure compartments.

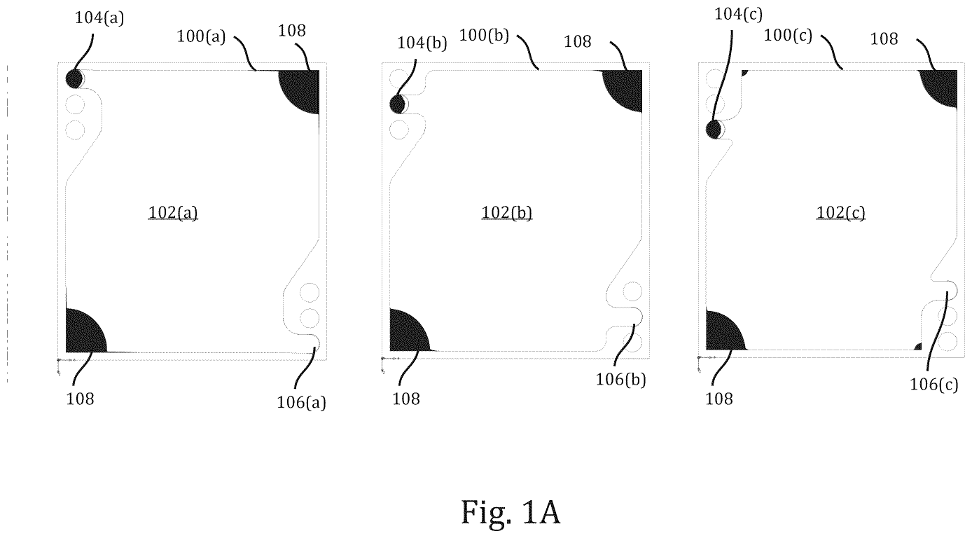

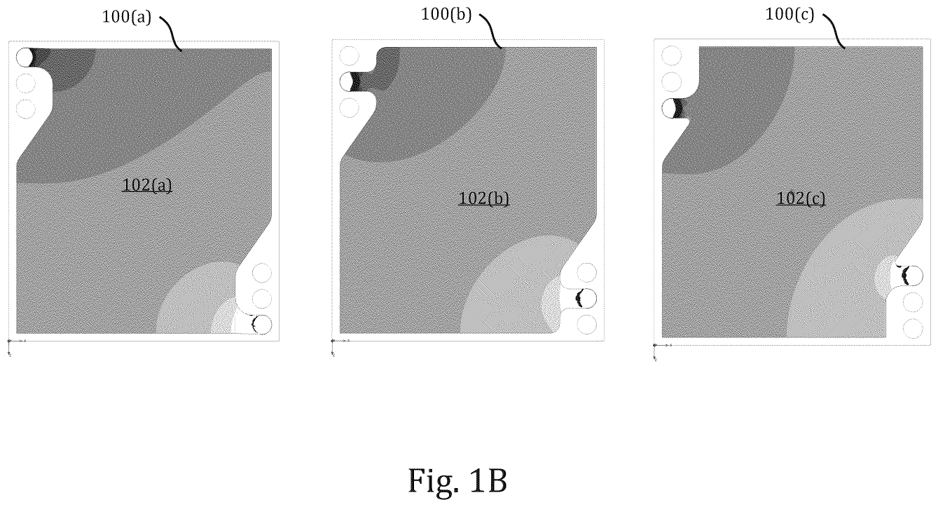

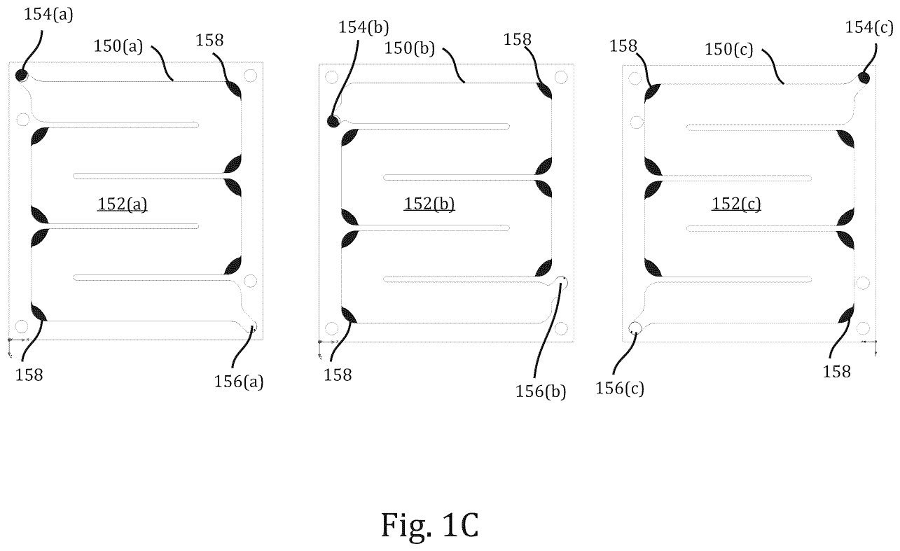

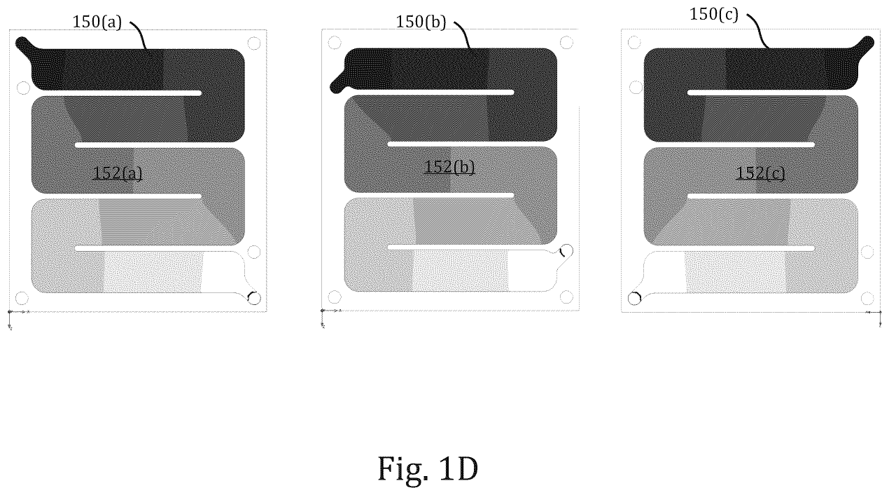

An example electrodialysis system that can produce substantial differential pressures is illustrated in FIGS. 1A-1B, which shows a set of three spacers 100(a), 100(b), 100(c) (collectively spacers 100). Each of the spacers 100 includes a fluid manifold 102(a), 102(b), and 102(c), respectively (collectively manifolds 102). The first spacer 100(a) includes a first inlet 104(a) and a first outlet 106(a). The second spacer 100(b) includes a second inlet 104(b) and a second outlet 106(b). The third spacer 100(c) includes a third inlet 104(c) and a third outlet 106(c). FIG. 1A illustrates fluid velocity in the manifolds 102 generated by a computer simulation of a pressure differential of 0.5 bar. In the illustrated computer simulation, the fluid velocity is determined in the absence of a mesh support. As such the actual flow with a spacer mesh present would be significantly lower. The dark portions 108 illustrate regions of the manifolds 102 that have significantly reduced flow compared to the rest of the flow path through the manifolds 102. For example, in FIG. 1A, the dark portions 108 illustrate regions having a flow velocity of 8 cm/s or less in a channel without a mesh support. FIG. 1B illustrates pressure distribution in each of the manifolds 102 generated by a computer simulation of a pressure differential of 0.5 bar. FIG. 1B illustrates that the pressure profile in the spacers 100(a), 100(b), and 100(c) are not the same.

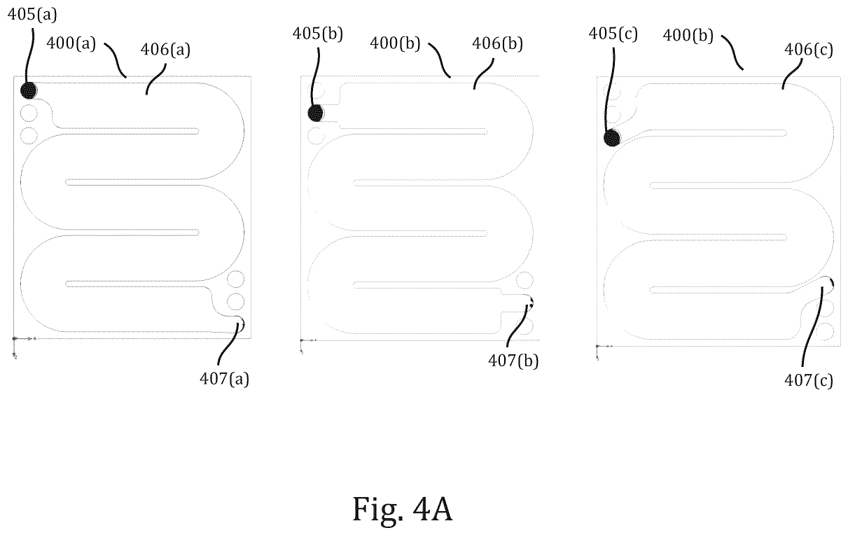

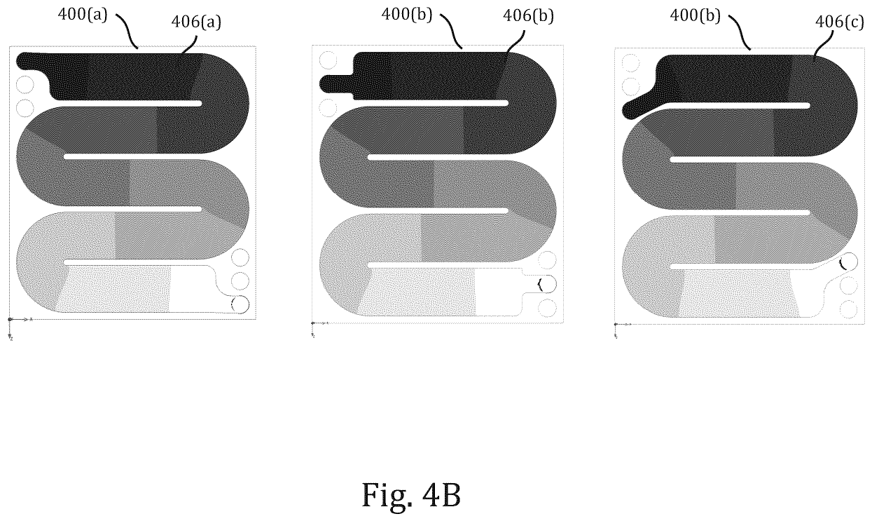

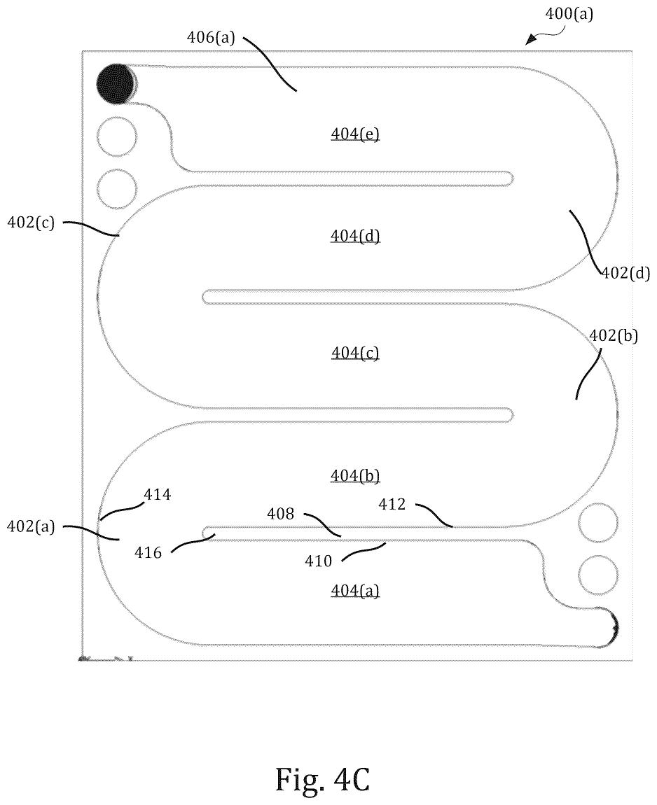

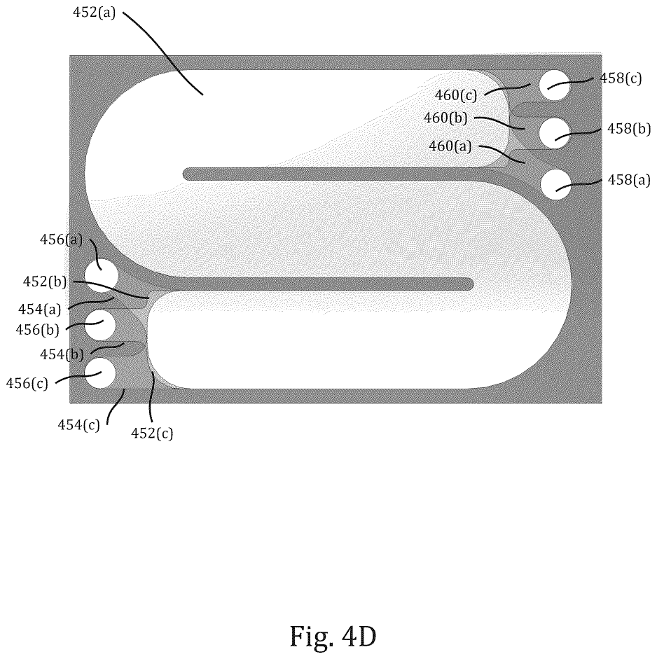

Another example electrodialysis system that can produce substantial differential pressures and dead zones is illustrated in FIGS. 1C-1D. which shows a set of three spacers 150(a), 150(b), 150(c) (collectively spacers 150). Each of the spacers 150 includes a serpentine flow path 152(a), 152(b), and 152(c), respectively (collectively flow paths 152). The first spacer 150(a) includes a first inlet 154(a) and a first outlet 156(a). The second spacer 150(b) includes a second inlet 154(b) and a second outlet 156(b). The third spacer 150(c) includes a third inlet 154(c) and a third outlet 156(c). FIG. 1C illustrates fluid velocity in the flow paths 152 generated by a computer simulation of a pressure differential of 0.5 bar. The dark portions 158 illustrate regions of the flow paths 152 that have less than significantly reduced flow compared to the rest of the flow paths 152. For example, in FIG. 1C, the dark portions 108 illustrate regions having a flow velocity of 8 cm/s or less. FIG. 1D illustrates pressure distribution in each of the flow paths 152 generated by a computer simulation of a pressure differential of 0.5 bar. FIG. 1D shows that the serpentine flow paths 152 exhibit pressure mismatches between the inlets and outlets of the flow path 152(a) and the flow path 152(b) as compared to the flow path 152(c), as compared to, for example, embodiments illustrated hereinbelow in connection with FIGS. 4A-4D.

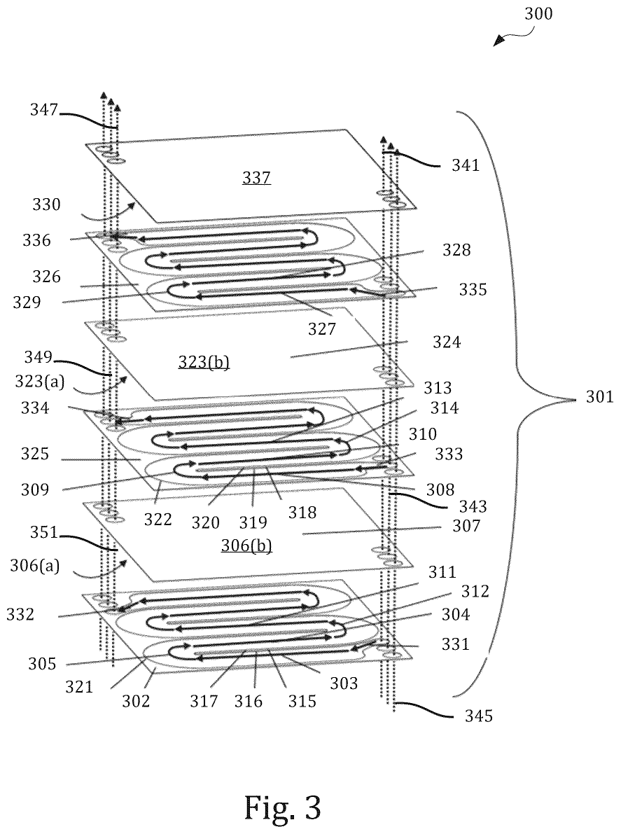

In some aspects of what is described here, electrodialysis systems can be designed to improve fluid flow and differential pressures. In some instances, a membrane stack separation apparatus featuring a redesigned flow arrangement can reduce or eliminate the types of dead zones illustrated in FIGS. 1A-1D which can reduce differential pressures on the membranes. For example, the example spacers shown in FIGS. 3-4D may operate without producing substantial differential pressures across ion exchange membranes. In some cases, the placement and structuring of manifold holes and connecting channels within the gasketing region of a spacer can also enhance flow dynamics, improve pressure control, and substantially mitigate cross-leakage. These and other features may allow for more precise control over fluid streams, reducing membrane deformation and enabling the effective use of thinner, higher-performance membranes.

Various aspects of the disclosure include several attendant advantages. For example, pressure matching between flow chambers improves a faradaic efficiency and energy efficiency of an electrodialysis system and allows the use of thinner membranes that are mechanically weaker and have lower resistivity. This improves voltage efficiency and overall energy efficiency of the electrodialysis system. Aspects of the disclosure also lead to better solution flow across an active area of the membrane. This prevents polarization resistance, which is an increased resistance that can be seen in an electrodialysis stack if insufficient mixing of the solution allows for ion concentration near a membrane to become depleted. Better solution flow across the active area of the membrane also leads to more uniform use of the membrane area, which minimizes voltage and improves energy efficiency and prevents hot spots, which are deleterious for membrane lifetime. Higher flow velocity allows for higher current density without significant polarization resistance. Use of higher current densities allows for minimization of capital expenditures.

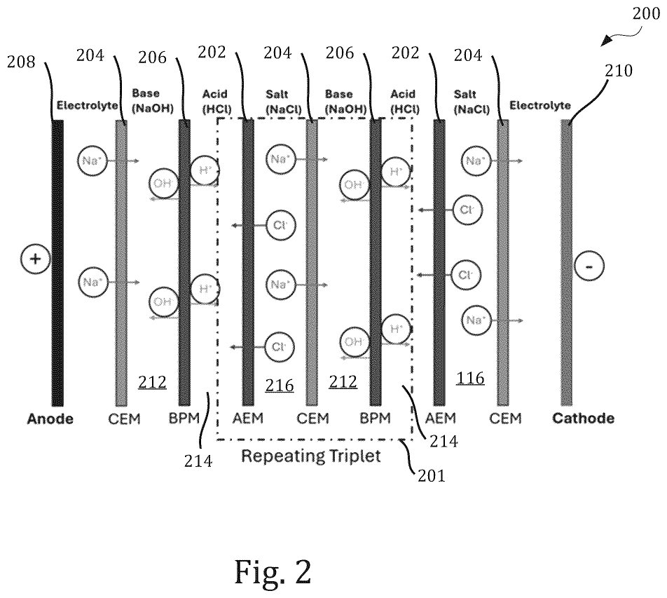

FIG. 2 is a schematic diagram illustrating ion exchange membranes, water dissociation, and ion transport in an example bipolar electrodialysis stack 200. The example bipolar electrodialysis stack 200 includes a stack of layers arranged between an anode 208 and a cathode 210. The stack of layers includes spacers and ion exchange membranes, with the ion exchange membranes arranged as repeating triplets that form respective electrodialysis cells 201. In the stack of layers, each of the spacers is disposed between a neighboring pair of the ion exchange membranes. The example bipolar electrodialysis stack 200 may include additional or different features.

In the example shown in FIG. 2, the triplet of ion exchange membranes in each electrodialysis cells 201 includes an anion exchange membrane (AEM) 202, a cation exchange membrane (CEM) 204, and a bipolar exchange membrane (BPM) 206. The anion exchange membrane 202, the cation exchange membrane 204, and the bipolar exchange membrane 206 are semi permeable membranes that transport certain dissolved ions while blocking transport of other ions. For example, the anion exchange membrane 202 facilitates the transport of negatively-charged ions while blocking the transport of positively-charged ions. The cation exchange membrane 204 facilitates the transport of positively-charged ions while blocking the transport of negatively charged ions. The bipolar exchange membrane 206 facilitates the transport of both positively charged and negatively charged ions in opposite directions, through the dissociation of water into protons and hydroxide ions. In various implementations, the bipolar electrodialysis stack 200 may include any number of electrodialysis cells 201 such as, for example, one, two, three, four, or more electrodialysis cells 201.

In some aspects of operation, during an electrodialysis process, a potential difference is applied between the anode 208 and the cathode 210 thereby causing the bipolar electrodialysis stack 200 to operate in an electric field. Water is circulated through channels 212 and 214 on either side of the bipolar exchange membrane 206. A salt solution such as, for example, sodium chloride (NaCl) is circulated through channel 216 between the anion exchange membrane 202 and the cation exchange membrane 204.

Application of the electric field causes water from the channels 212 and 214, which has migrated into the bipolar membrane 206, to dissociate within the bipolar membrane 206 into positively charged hydrogen ions (H⁺) and negatively charged hydroxide ions (OH⁻) according to the reaction

2H₂O→H₃O⁺+OH⁻.

In the above reaction, a positively charged hydrogen ion (H⁺) bonds with a water molecule to form the ion H₃O⁺. In similar fashion, application of the electric field also causes the salt present in channel 216 to dissociate into positively charged sodium ions (Na⁺) and negatively charged chlorine ions (Cl⁻) according to the reaction

NaCl→Na⁺_{(aq)}+Cl⁻_{(aq)}.

The polarity of the electric field induces movement of the positively charged (H⁺) and (Na⁺) ions towards the negatively charged cathode 210 and movement of the negatively charged (OH⁻) and (Cl⁻) ions towards the positively charged anode 208. However, movement of the ions may be limited by the ion exchange membranes.

Protons or hydronium ions generated within the bipolar membrane 206 are transported into channel 214. The anion exchange membrane 202 blocks further lateral migration by protons or hydronium ions. Similarly, hydroxide ions generated within the bipolar membrane 206 are transported into channel 212. The cation exchange membrane 204 blocks further lateral migration of the hydroxide ions. The net effect of the water dissociation in the bipolar membrane is therefore to create protons or hydronium in channel 214 and to create hydroxide ions in channel 212.

From the channel 216 between the anion exchange membrane 202 and the cation exchange membrane 204, the positively charged sodium (Na⁺) ions are transported across the cation exchange membrane 204 into the channel 212 on the opposite side of the cation exchange membrane 204 while the negatively charged chlorine (Cl⁻) ions are transported across the anion exchange membrane 202 into the channel 214 on the opposite side of the anion exchange membrane 202. Both the Cl⁻ ions and the Na+ions are blocked from further movement by the bipolar membrane 206. In channel 212, the Cl⁻ ions combine with the H⁺ ions to form hydrochloric acid (HCl) according to the reaction

[H₃O]⁺+Cl⁻→H₂O+HCl.

In channel 214, the Na⁺ions react with the OH-to form sodium hydroxide (NaOH) according to the reaction

Na⁺+OH⁻→NaOH.

Thus, an acid stream is created in channel 212 and an alkaline stream is created in channel 214. A dilute salt stream remains in channel 216. The above reactions are listed here to show the net stoichiometric creation of acid and base. In most cases, the acid and base will remain fully dissociated in aqueous solution.

In various implementations, the bipolar electrodialysis stack 200 may be utilized, for example, to generate an acid stream and an alkaline stream from seawater. The acid stream and the alkaline stream may then be used in connection with, for example, a pH swing direct ocean carbon capture process or another process.

FIG. 3 is a schematic diagram illustrating a plurality of layers and flow paths in an example electrodialysis stack 300. In some implementations, the electrodialysis stack 300 may be deployed as the bipolar electrodialysis stack 200 illustrated in FIG. 2. For instance, each of the electrodialysis cells 201 in FIG. 2 may include the stack of layers shown in FIG. 3. In some cases, the example electrodialysis stack 300 may be deployed in another type of system, and the example electrodialysis stack 300 may include additional or different features.

As shown in FIG. 3, the example electrodialysis stack 300 includes a stack of layers 301, which includes spacers disposed between neighboring ion exchange membrane. The ion exchange membranes can include, for example, the anion exchange membrane 202, the cation exchange membrane 204, and the bipolar membrane 206 illustrated in FIG. 2 or another ion exchange membrane. Each of the spacers shown in FIG. 3 defines a flow path that allows fluid flow within the electrodialysis stack 300. For example, the flow paths provided by the spacers in FIG. 3 may provide fluid flow within the channels 212, 214, 216 as described with respect to FIG. 2. For instance, the flow paths defined by the example spacers may provide flow between a cation exchange membrane and a bipolar membrane, between a bipolar membrane and an anion exchange membrane, or between an anion exchange membrane and a cation exchange membrane.

As shown in FIG. 3, an ion exchange membrane 307 is disposed between a first spacer 302 and a second spacer 325. In various implementations, the ion exchange membrane 307 may be, for example, the anion exchange membrane 202, the cation exchange membrane 204, the bipolar membrane 206 illustrated in FIG. 2 or another membrane. The first spacer 302 or the second spacer 325 may be disposed in the channel 212, the channel 214, or the channel 216 illustrated in FIG. 2.

As shown in FIG. 3, a first spacer 302 has interior boundaries that define a first flow path in the example electrodialysis stack 300. The first flow path contains a first linear section 303 of flow, a second linear section 304 of flow, and an arcuate section 305 connecting the first linear section 303 and the second linear section 304. The first and second linear sections (303, 304) of the first flow path direct flow in opposite directions (to the left and to the right, respectively, in FIG. 3). The arcuate section 305 directs fluid flow across an arcuate area of the first surface 306(a). The first linear section 303, the second linear section 304, and the arcuate section 305 contact a first surface 306(a) of an ion exchange membrane 307 and direct fluid across a first area and a second area of the first ion exchange membrane 307, respectively. A second surface 306(b) of the ion exchange membrane 307 is contacted by a second spacer 325. The second surface 306(b) is opposite the first surface 306(a).

As shown in FIG. 3, the second spacer 325 has interior boundaries that define a second flow path in the example electrodialysis stack 300. The second flow path contains a first linear section 308 and a second linear section 310. The first and second linear sections (308, 310) of the second flow path direct flow in opposite directions (to the left and to the right, respectively, in FIG. 3). The first linear section 308 and the second linear section 310 direct fluid flow across a first area and a second area of the second surface 306(b) of the first ion exchange membrane 307, respectively. The first linear section 308 and the second linear section 310 are connected by an arcuate section 309, which directs fluid flow across an arcuate area of the second surface 306(b).

As shown in FIG. 3, the first and second spacers 302, 325 define flow paths on coextensive areas of the first and second surfaces 306(a), 306(b). That is, the flow path defined in the first spacer has corresponding spatial boundaries as the flow path defined in the second spacer such that the fluid present in the flow path in the first spacer 302 contacts a region of the first surface 306(a) that has the same spatial boundaries as a region contacted by a fluid present in the flow path in the second spacer 325 on the second surface 306(b). For example, the first linear section 303 (defined by the first spacer 302) directs flow across an area A₁ on the first surface 306(a), and the first linear section 308 (defined by the second spacer 325) directs flow across an area A₂ on the second surface 306(b), and the areas A₁ and A₂ are coextensive. In other words, the areas A₁ and A₂ are aligned in registration, from a top-down view of the electrodialysis stack 300. Because the areas A₁ and A₂ are coextensive with each other on opposite sides of the membrane, a fluid pressure exerted on the area A₁ is balanced by a fluid pressure (of the same magnitude, but in the opposite direction) on the A₂. Similarly, the second linear section 304 (defined by the first spacer 302) directs flow across an area A₃ on the first surface 306(a), and the second linear section 310 (defined by the second spacer 325) directs flow across an area A₄ on the second surface 306(b), and the areas A₃ and A₄ are coextensive with each other. Similarly, the arcuate section 305 (defined by the first spacer 302) directs flow across an area A₅ on the first surface 306(a), and the arcuate section 309 (defined by the second spacer 325) directs flow across an area A₆ on the second surface 306(b), and the areas A₅ and A₆ are coextensive with each other.

Furthermore, in the example shown in FIG. 3, the inlets and outlets of the first and second spacers 302, 325 are arranged such that the flow paths defined by the first and second spacers 302, 325 direct flow in the same direction on areas that are coextensive with each other. In other words, fluid flows in the same direction across the coextensive areas A₁ and A₂ (to the left in FIG. 3), fluid flows in the same direction across the coextensive areas A₃ and A₄ (to the right in FIG. 3), and fluid flows in the same direction across the coextensive areas A₅ and A₆ (in an arcuate path between the linear sections), As shown in FIG. 3, the first spacer 302 and the second spacer 325 each contain additional linear sections and arcuate sections. For example, the first spacer 302 includes a third linear section 311 having flow in the same direction as the first linear section 303, and connected to the second linear section 304 by a second arcuate section 312. Likewise, the second spacer 325 includes a third linear section 313 that is connected to the second linear section 310 by a second arcuate section 314.

The first spacer 302 and the second spacer 325 contain interior boundaries that define the flow paths through the first spacer 302 and the second spacer 325. For example, the first spacer 302 contains a first wall 315 with a first side 316 which partially defines the first linear section 303. A second side 317 of the first wall 315 partially defines the second linear section 304. The first wall 315 is coextensive with a first wall 318 in the second spacer 325. The first wall 318 of the second spacer 325 contains a first side 319 which partially defines the first linear section 308 of the second flow channel, and a second side 320 which partially defines the second linear section 310 of the second flow channel. The first spacer 302 contains a first arced interior boundary 321. The first wall 315 terminates at a first end that, together with the first arced interior boundary 321, defines the arcuate section 305 of the first flow path. The second spacer 325 contains a second arced interior boundary 322. The first wall 318 of the second spacer 325 terminates at a second end that, together with the second arced interior boundary 322, defines the arcuate section 309 of the second flow path.

As shown in FIG. 3, the electrodialysis stack 300 includes a second ion exchange membrane 324 disposed between the second spacer 325 and a third spacer 326. The second ion exchange membrane 324 has a third surface 323(a) that contacts the second spacer 325. A fourth, opposite surface 323(b) of the second ion exchange membrane 324 contacts the third spacer 326. In various implementations, the second ion exchange membrane 324 may be, for example, the anion exchange membrane 202, the cation exchange membrane 204, the bipolar membrane 206 illustrated in FIG. 2 or another membrane. The third spacer 326 may be disposed in the channel 212, the channel 214, or the channel 216 illustrated in FIG. 2.

As shown in FIG. 3, the third spacer 326 has interior boundaries that define a third flow path in the example electrodialysis stack 300. The third flow path contains a flow path with a first linear section 327 that directs fluid flow across a first area of the fourth surface 323(b), a second linear section 328 that directs fluid flow across a second area of the fourth surface 323(b), and an arcuate section 329 which directs fluid flow across an arcuate area of the fourth surface 323(b). The first linear section 327, the second linear section 328, and the arcuate section 329 generally are coextensive with the corresponding flow paths in the first spacer 302 and the second spacer 325. As shown in FIG. 3, a fifth surface 330 of a third ion exchange membrane 337 contacts the third spacer 326. As shown, the first linear section 327 directs fluid flow across a first area of the fifth surface 330, the second linear section 328 directs fluid flow across a second area of the fifth surface 330, and the arcuate section 329 directs fluid flow across an arcuate area of the fifth surface 330.

Inlet ports and outlet ports are defined in the first spacer 302, the second spacer 325, and the third spacer 326 to allow fluids to enter and exit the flow paths defined by each respective spacer. In various implementations, the inlet ports and the outlet ports connect the flow channels of the first spacer 302, the second spacer 325, and the third spacer 326 to external fluid manifolds. As shown in FIG. 3, the first spacer 302 has an inlet 331 and an outlet 332 that allow flow to proceed from the inlet 331 to the outlet 332 through the flow path. The second spacer 325 has an inlet 333 and an outlet 334, and the third spacer 326 has an inlet 335 and an outlet 336. The inlets and outlets determine the direction of flow through the flow paths, as represented by the arrows in FIG. 3.

As illustrated in FIG. 3, the inlet 331 is coupled to a first inlet conduit 341 that supplies a first fluid to the flow path defined in the first spacer 302. The inlet 333 is coupled to a second inlet conduit 343 that is parallel to the first inlet conduit and supplies a second fluid to the flow path defined in the second spacer 325. The inlet 335 is coupled to a third inlet conduit 345 that is parallel to the first inlet conduit 341 and the second inlet conduit 343 and supplies a third fluid to the flow path defined in the third spacer 326. In various implementations, the first fluid, the second fluid, and the third fluid may be, for example, aqueous solutions (e.g., water), saline solutions, acidic solutions, basic solutions, or other types of fluid used in an electrodialysis process. The first inlet conduit 341, the second inlet conduit 343, and the third inlet conduit 345 pass through the first spacer 302, the first ion exchange membrane 307, the second spacer 325, the second ion exchange membrane 324, the third spacer 326, and the third ion exchange membrane 337. Similarly, the first outlet conduit 347, the second outlet conduit 349, and the third outlet conduit 351 pass through the first spacer 302, the first ion exchange membrane 307, the second spacer 325, the second ion exchange membrane 324, the third spacer 326, and the third ion exchange membrane 337. In some implementations, the first inlet conduit 341, the second inlet conduit 343, and the third inlet conduit 345 are formed from aligned holes or gaps that are emplaced into the first spacer 302, the second spacer 325, and the third spacer 326 as well as the first ion exchange membrane 307, the second ion exchange membrane 324, and the third ion exchange membrane 337.

As illustrated in FIG. 3, the outlet 332 is coupled to a first outlet conduit 347 that removes the first fluid from the flow path defined in the first spacer 302. The outlet 334 is coupled to a second outlet conduit 349 that is parallel to the first outlet conduit 347 and removes the second fluid from the flow path defined in the second spacer 325. The outlet 336 is coupled to a third outlet conduit 351 that is parallel to the first outlet conduit 347 and the second outlet conduit 349 and removes a third fluid from the flow path defined in the third spacer 326. In various implementations, the first fluid, the second fluid, and the third fluid may be, for example, aqueous solutions (e.g., water), saline solutions, acidic solutions, basic solutions, or other types of fluid used in an electrodialysis process.

In some aspects of operation, fluid flow through the first spacer 302 exerts pressure on the first surface 306(a) of the first ion exchange membrane 307. Similarly, fluid flow through the second spacer 325 exerts pressure on the second surface 306(b) of the first ion exchange membrane 307. If the pressures exerted by the fluid flow through the first spacer 302 and the second spacer 325 are unbalanced, the pressures can cause deformation of the first ion exchange membrane 302 towards one side or the other. Such deformation can result in reduced fluid flow through either the first spacer 302 or the second spacer 325, or a buildup of fluid pressure through the first spacer 302 or the second spacer 325. The example spacers shown in FIG. 3 can produce fluid flow that reduces or avoids such pressure imbalances. As shown, the flow path in the first spacer 302 is coextensive with the flow path in the flow path in the second spacer 325 and the third spacer 326. Additionally, fluid flow through the flow path in the first spacer 302 is in the same direction as fluid flow through the flow path in the second spacer 325 and the third spacer 326. Such an arrangement reduce or eliminate imbalances between the pressure profiles on the first surface 306(a) and the second surface 306(b) of the first ion exchange membrane 307. By matching pressures on opposite sides of the membrane (reducing or eliminating pressure imbalances), deformation of the membrane can also be reduced or eliminated. In various implementations, such an arrangement facilitates the use of ion exchange membranes of decreased thickness. For example, the electrodialysis stack 300 may include ion exchange membranes with a thickness in the range of 10 to 500 micrometers (μm). For instance, an ion exchange membrane with a thickness of approximately 10, 50, 70, 100, 200, 300, 400 or 500 micrometers (μm) may be used. Additionally, in various implementations the ion exchange membranes used in the electrodialysis stack 300 may be self supporting. That is, in some cases, the ion exchange membranes of the electrodialysis stack 300 may not require a supporting mesh layer to prevent deflection or deformation of the ion exchange membranes.

In various implementations, the first side 306(a) of the first ion exchange membrane 307 is sealed to the first spacer 302 and the second side 306(b) of the first ion exchange membrane 307 is sealed to the second spacer 325. In various implementations, the seal may be a chemical seal utilizing, for example, adhesives or other fluid impermeable barriers. In other implementations, the seal may be a mechanical seal such as gaskets, flexible seals, or other devices or a face seal between, for example, the spacer 302 and the first side 306(a) of the first ion exchange membrane 307. For instance, in various implementations, the seal may include a gasket constructed from a soft rubber material or a firmer plastic-based material. For example, in various implementations, a gasket may be constructed of rubbers including but not limited to Natural Rubber (NR), Styrene-Butadiene Rubber (SBR), Butyl Rubber (IIR), Nitrile Rubber (NBR), Neoprene (CR), Ethylene Propylene Diene Monomer (EPDM), Silicone Rubber (Q), Polyurethane Rubber (PU), Fluoroelastomers (FKM), Thermoplastic Rubber (TPR), Chloroprene Rubber, Hydrogenated Nitrile Rubber (HNBR), Epichlorohydrin Rubber (ECO), Acrylic Rubber (ACM), Styrene-Ethylene-Butylene-Styrene (SEBS). including but not limited to Polyethylene Terephthalate (PET), High-Density Polyethylene (HDPE), Polyvinyl Chloride (PVC), Low-Density Polyethylene (LDPE), Polypropylene (PP), Polystyrene (PS), Acrylonitrile Butadiene Styrene (ABS), Polycarbonate (PC), Polymethyl Methacrylate (PMMA), Polyethylene (PE), Polyamide (Nylon), Polyoxymethylene (POM), Polyethylene Glycol (PEG), Polyurethane (PU), Polytetrafluoroethylene (PTFE), Polyether Ether Ketone (PEEK), Polyphenylene Sulfide (PPS), Polyimide (PI), Polysulfone (PSU), Liquid Crystal Polymer (LCP), Polyvinylidene Fluoride (PVDF), Ethylene Vinyl Acetate (EVA), Polybutylene Terephthalate (PBT), Polytrimethylene Terephthalate (PTT), Thermoplastic Polyolefin (TPO). In various implementations, a gasket may have a thickness of 1 mm to 3 mm.

In similar fashion the third surface 323(a) of the second ion exchange membrane 324 is sealed to the second spacer 325 and the fourth surface 323(b) of the second ion exchange membrane 324 is sealed to the third spacer 326. In various implementations, the fifth surface 330 of the third ion exchange membrane 337 is sealed to the third spacer 326. In various implementations, sealing of the ion exchange membranes to the spacers prevents loss of fluid from the flow channels and resulting loss of pressure in the first spacer 302, the second spacer 325, and the third spacer 326.

FIG. 4A is an illustration of velocity contours of fluid flow in example spacers 400(a), 400(b), and 400(c) (collectively spacers 400). In various implementations, the example spacer 400(a) may be the first spacer 302 or another spacer, the example spacer 400(b) may be the second spacer 325 or another spacer, and the example spacer 400(c) may be the third spacer 326, or another spacer. The example spacers 400 may be used in conjunction with an electrodialysis stack such as, for example, the electrodialysis stack 200 illustrated in FIG. 2, the electrodialysis stack 300 illustrated in FIG. 3, or another electrodialysis stack. The example spacer 400(a) shown in FIG. 4A includes an inlet 405(a), an outlet 407(a) and a flow path 406(a) between the inlet 405(a) and the outlet 407(a). The example spacer 400(b) shown in FIG. 4A includes an inlet 405(b), an outlet 407(b) and a flow path 406(b) between the inlet 405(b) and the outlet 407(b). The example spacer 400(c) shown in FIG. 4A includes an inlet 405(c), an outlet 407(c) and a flow path 406(c) between the inlet 405(c) and the outlet 407(c).

The velocity contours represented in FIG. 4A were generated by a computer simulation of a pressure differential of 0.5 bar between the inlet 405 and the outlet 407.

When compared to the simulations illustrated in FIGS. 1A-1D, the example flow spacers 400 illustrates no areas of fluid stagnation; generally, there are no regions with lateral fluid velocity in the flow channel below 8 cm/s.

FIG. 4B illustrates pressure contours within the flow paths 406(a), 406(b), and 406(c) formed within the spacers 400(a), 400(b), and 400(c), respectively. The pressure contours illustrated in FIG. 4B were generated by a computer simulation of a pressure differential of 0.5 bar. FIG. 4B illustrates uniform pressure drop through the flow paths 406. Additionally, the pressures in the flow path 406(a), 406(b), and 406(c) are matched such that uniform pressure is exerted on opposite sides of the ion exchange membranes.

FIG. 4C is a detailed view of the spacer 404(a). While FIG. 4C illustrates the example spacer 400(a), it will be understood that the spacer 400(b) and the spacer 400(c) are constructed in similar fashion. The flow path 406(a) includes linear sections 404(a), 404(b), 404(c), 404(d), 404(e) (collectively, linear sections 404) and arcuate sections 402(a), 402(b), 402(c), 402(d) (collectively, arcuate sections 402). In various implementations, the arcuate sections 402 may be the arcuate sections 305, 309, 312, 314, or 329 described in FIG. 3 or another arcuate section. In various implementations, the linear sections 404 may be the linear sections 303, 308, 310, 312, 327, or 328 described in FIG. 3 or another linear section.

As shown in FIG. 4C, each of the arcuate sections 402 connects a respective pair of the linear sections 404, and the arcuate sections 402 create a smooth flow transition between the linear sections 404. In the example shown, the shape of the arcuate sections 402 maintains fluid flow velocities above 0.8 cm/s throughout the flow channel and facilitates a pressure differential of 0.5 bar, between an inlet 405 and an outlet 407. Additionally, the shape of the flow path can reduce or prevent the formation of stagnant or dead flow zones where fluid flow is minimal. Such an arrangement facilitates equalization of the pressure profile on either side of the ion exchange membrane and prevents deformation or deflection of the ion exchange membrane due to unbalanced pressure.

As shown in FIG. 4C, interior boundaries of the spacer 400(a) define the shape of the flow path 406. In various implementations, the spacer 400(a) includes a first wall 408 with a first side 410 that partially defines the first linear section 404(a). A second side 412 of the first wall 408 partially defines the second linear section 404(b). In various implementations, the spacer 400 contains an arced interior boundary 414. The first wall 408 terminates at a first end 416 that, together with the arced interior boundary 414, defines the arcuate section 402 of the first flow path. Although the spacer 400 illustrated as having five linear sections 404(a), 404(b), 404(c), 404(d), and 404(e), in various implementations, spacers may include any number of linear sections such as, for example, one, two, three, four, five, or more linear sections. Similarly, while the spacer 400(a) is illustrated as having four arcuate sections 402(a), 402(b), 402(c), and 402(d), spacers may include any number of arcuate sections such as, for example, one, two, three, four, or more arcuate sections. In various implementations, material such as, for example, a mesh may be used to maintain spacing in the flow path 406 and create seals at the inlet 405 and the outlet 407. The mesh may be of any type such as, for example, woven, biplanar, expanded, or nonwoven.

FIG. 4D is a plan view illustrating multiple stacked spacers of an example electrodialysis system 450. In various implementations, the spacers 452(a), 452(b), 452(c) may be, for example, the first spacer 302, the second spacer 325, or the third spacer 326 illustrated in FIG. 4A or another spacer. When positioned in the electrodialysis stack, the spacers 452(a), 452(b), 452(c) are stacked and aligned in registry such that flow paths defined in each of the spacers 452(a), 452(b), 452(c) align in registry thereby causing fluid present in the flow paths defined in the spacers 452(a), 452(b), 452(c) to trace corresponding areas on the ion exchange membranes. A first inlet conduit 454(a), a second inlet conduit 454(b), and a third inlet conduit 454(c) are formed through the spacers 452(a), 452(b), 452(c). The first inlet conduit 454(a) is coupled to a first inlet 456(a) of the first spacer 452(a). The second inlet conduit 454(b) is coupled to a second inlet 456(b) of the second spacer 452(b). The third inlet conduit 454(c) is coupled to a third inlet 456(c) of the third spacer 452(c). Similarly, a first outlet conduit 458(a), a second outlet conduit 458(b), and a third outlet conduit 458(c) are formed through the spacers 452(a), 452(b), 452(c). The first outlet conduit 458(a) is coupled to a first outlet 460(a) of the first spacer 452(a). The second outlet conduit 458(b) is coupled to a second outlet 460(b) of the second spacer 452(b). The third outlet conduit 458(c) is coupled to a third outlet 460(c) of the third spacer 452(c).

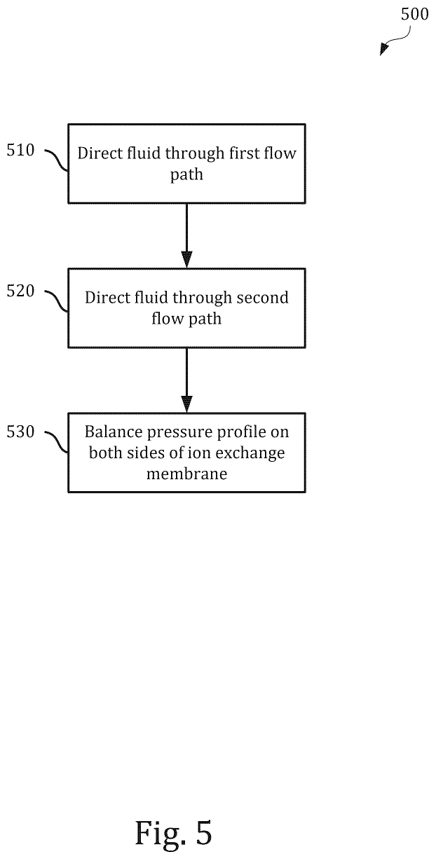

FIG. 5 is a flow diagram illustrating an example process 500 for electrodialysis. An electrodialysis system may be, for example, the electrodialysis stack 300 illustrated in FIG. 3 or another electrodialysis system. The electrodialysis stack can equalize or otherwise improve a pressure profile on opposite sides of an ion exchange membrane thereby facilitating use of thinner ion exchange membranes that do not require a supporting mesh. Further, the electrodialysis stack may reduce the presences of stagnant fluid or “dead flow zones” within the flow path. The example process 500 may include additional or different operations, and the operations may be performed in the order shown or in another order. In some cases, one or more of the operations shown in FIG. 5 can be implemented as a process that includes multiple operations, sub-processes, or other types of routines. In some cases, operations can be combined, performed in another order, performed in parallel, iterated or otherwise repeated, or performed in another manner.

At 510, a first fluid flow is directed through a first flow path and across a first surface of an ion exchange membrane. The fluid may include, for example, an aqueous solution (e.g., water), a saline solution, an acidic solution, a basic solution, or another type of fluid used in an electrodialysis process. The first flow path may be defined by interior boundaries of a spacer that contacts the first surface of the ion exchange membrane. In various implementations, the flow path may be formed in the first spacer 302, the second spacer 325, the third spacer 326, or another spacer. The ion exchange membrane may be, for example, the first ion exchange membrane 307, the second ion exchange membrane 324, or the third ion exhalation membrane 337 illustrated in FIG. 3 or another ion exchange membrane. In various implementations, the first flow path includes a first linear section and a second linear section that directs flow in a direction opposite the first linear section. In various implementations, the first linear section and the second linear section are connected by an arcuate section.

At 520, a second fluid flow is directed through a second flow path and across a second, opposite surface of the ion exchange membrane. The fluid may include, for example, an aqueous solution (e.g., water), a saline solution (e.g., salt water), an acidic solution, a basic solution, or another type of fluid used in an electrodialysis process. The second flow path may be defined by interior boundaries of another spacer that contacts the second surface of the ion exchange membrane. In various implementations, the flow path may be formed in the first spacer 302, the second spacer 325, the third spacer 326, or another spacer. The ion exchange membrane may be, for example, the first ion exchange membrane 307, the second ion exchange membrane 324, or the third ion exhalation membrane 337 illustrated in FIG. 3 or another ion exchange membrane. In various implementations, the second flow path includes a first linear section and a second linear section that directs flow in a direction opposite the first linear section. In various implementations, the first linear section and the second linear section are connected by an arcuate section.

At 530, a pressure profile is balanced on both sides of the ion exchange membrane. For example, the first and second flow paths may cover coextensive areas of the first and second surfaces, with flow in the same direction on each pair of coextensive areas (on opposite sides of the membrane). In such an arrangement, a pressure exerted by fluid in the first flow path can be balanced by an equal and opposite pressure exerted by fluid in the second flow path. For example, the pressure profile of fluid in each section of the first flow path (e.g., the first linear section, the second linear section, the arcuate section, etc.) can be balanced by the pressure profile of fluid in the corresponding section of the second flow path, as the corresponding sections cover coextensive areas on opposite sides of the membrane. In various implementations, such an arrangement facilitates the use of thinner membranes, for example, ion exchange membrane having a thickness of approximately 70 micrometers (μm) or less, or in the range of 10 to 500 micrometers (μm). Additionally, the balanced pressure profile exerted on the sides of the ion exchange membrane allows the ion exchange membrane to function without a supporting structure such as, for example, a supporting mesh.

In a general aspect, fluid flow is directed in an electrodialysis system.

In a first example, aspects of the disclosure relate to an electrodialysis stack that includes a plurality of layers disposed between an anode and a cathode. The plurality of layers includes a plurality of ion exchange membranes. The plurality of ion exchange membranes include a first ion exchange membranes that includes a first surface and a second opposite surface. The plurality of layers also includes a plurality of spacers. The plurality of spacers include a first spacer that contacts the first surface of the first ion exchange membrane. The first spacer includes interior boundaries that define a first flow path across the first surface of the first ion exchange membrane. The first flow path includes a first linear section that directs flow in a first direction across a first area of the first surface and a second linear section that directs flow in a second, opposite direction across a second area of the first surface, and an arcuate section that directs flow from the first linear section of the first flow path, across an arcuate section of the first surface, to the second linear section of the first flow path. The plurality of spacers includes a second spacer that contacts the second surface of the first ion exchange membrane and includes interior boundaries that define a second flow path across the second surface of the first ion exchange membrane. The second flow path includes a first linear section that directs flow in a first direction across a first area of the second surface, the first area of the second surface being coextensive with the first area of the first surface, a second linear section that directs flow in a second direction across a second area of the second surface, the second area of the second surface being coextensive with the second area of the first surface, and an arcuate section that directs flow from the first linear section of the second flow path, across an arcuate section of the second surface, to the second linear section of the second flow path. The arcuate section of the second surface is coextensive with the arcuate section of the first surface.

In various implementations of the first example, the first spacer includes a third linear section that directs flow in the first direction across a third area of the first surface and a second arcuate section that directs flow from the second linear section of the first flow path, across a second arcuate section of the first surface, to the third linear section of the first flow path. The second spacer includes a third linear section that directs flow in the first direction across a third area of the second surface. The third area of the second surface being coextensive with the third area of the first surface and a second arcuate section that directs flow from the second linear section of the second flow path, across a second arcuate section of the second surface, to the third linear section of the second flow path, the second arcuate section of the second surface being coextensive with the second arcuate section of the first surface.

In various implementations of the first example, the first spacer includes a first wall that has a first side that partially defines the first linear section of the first flow path and a second, opposite, side that partially defines the second linear section of the first flow path. The second spacer includes a first side that partially defines the first linear section of the second flow path and a second, opposite, side that partially defines the second linear section of the second flow path. In such implementations of the first example, the first spacer may include a first arced interior boundary. A first wall terminates at a first end that, together with the first arced interior boundary, defines the arcuate section of the first flow path. The second spacer may include a second arced interior boundary. The second wall terminates at a second end that, together with the second arced interior boundary, defines the arcuate section of the second flow path.

In various implementations of the first example, the plurality of layers includes a second ion exchange membrane that includes a third surface and a fourth, opposite, surface. The second spacer contacts the third surface of the second ion exchange membrane. The first linear section of the second flow path directs flow across a first area of the third surface. A second linear section of the second flow path directs flow across a second area of the third surface, and the arcuate section of the second flow path directs flow across a second arcuate section of the third surface. The plurality of spacers includes a third spacer that contacts the fourth surface of the second ion exchange membrane. The third spacer includes interior boundaries that define a third flow path across the fourth surface of the second ion exchange membrane. The third flow path includes a first linear section that directs flow in a first direction across a first area of the fourth surface and a second linear section that directs flow in a second, opposite direction across a second area of the fourth surface. The second area of the fourth surface is coextensive with the second area of the third surface. An arcuate section directs flow from the first linear section of the third flow path, across a second arcuate section of the fourth surface, to the second linear section of the third flow path. The second arcuate section of the fourth surface is coextensive with the second arcuate section of the third surface. In such implementations of the first example, the plurality of layers may include a third ion exchange membrane that includes a fifth surface. The third spacer contacts the fifth surface of the third ion exchange membrane. The first linear section of the third flow path directs flow across a first area of the fifth surface, the second linear section of the third flow path directs flow across the second area of the fifth surface, and the arcuate section of the third flow path directs flow across a third arcuate section of the fifth surface.

In various implementations of the first example, the first spacer includes interior boundaries that define a first inlet that directs flow to the first flow path and a first outlet that receives flow from the first flow path. The second spacer includes interior boundaries that define a second inlet that directs flow to the second flow path and a second outlet that receives flow from the second flow path. The third spacer includes interior boundaries that define a third inlet that directs flow to the third flow path and a third outlet that receives flow from the third flow path.

In various implementations of the first example, the first flow path and the second flow path are configured to balance pressure across the first ion exchange membrane. The arcuate sections of the first flow path and the second flow path are shaped to prevent dead flow zones in the arcuate sections. The first ion exchange membrane has a thickness of less than or equal to 70 micrometers. The first ion exchange membrane has a thickness in the range of 10 to 500 micrometers (μm). The first spacer and the second spacer contact the first ion exchange membrane to form a seal about the first flow path and the second flow path. The first ion exchange membrane includes at least one of an anion exchange membrane, a cation exchange membrane, or a bipolar membrane.

In a second example, aspects of the disclosure relate to an electrodialysis method. The method includes directing a first fluid through a first flow path that is defined by interior boundaries in a first spacer. The first flow path includes a first linear section that directs flow in a first direction across a first area of the first surface, a second linear section that directs flow in a second, opposite, direction across a second area of the first surface, and an arcuate section that directs flow from the first linear section of the first flow path, across an arcuate section of the first surface, to the second linear section of the first flow path. The method includes directing a second fluid through a second flow path across a second, opposite, surface of the ion exchange membrane. The second flow path is defined by interior boundaries of a second spacer and includes a first linear section that directs flow in the first direction across a first area of the second surface. The first area of the second surface is coextensive with the first area of the first surface. The second flow path includes a second linear section that directs flow in the second direction across a second area of the second surface, the second area of the second surface is coextensive with the second area of the first surface. An arcuate section directs flow from the first linear section of the second flow path, across an arcuate section of the second surface, to the second linear section of the second flow path. The arcuate section of the second surface is coextensive with the arcuate section of the first surface.

In various implementations of the second example, the first spacer includes a third linear section that directs flow in the first direction across a third area of the first surface and a second arcuate section that directs flow from the second linear section of the first flow path, across a second arcuate section of the first surface, to the third linear section of the first flow path. The second spacer includes a third linear section that directs flow in the first direction across a third area of the second surface. The third area of the second surface being coextensive with the third area of the first surface and a second arcuate section that directs flow from the second linear section of the second flow path, across a second arcuate section of the second surface, to the third linear section of the second flow path, the second arcuate section of the second surface being coextensive with the second arcuate section of the first surface.

In various implementations of the second example, the first spacer includes a first wall that has a first side that partially defines the first linear section of the first flow path and a second, opposite, side that partially defines the second linear section of the first flow path. The second spacer includes a first side that partially defines the first linear section of the second flow path and a second, opposite, side that partially defines the second linear section of the second flow path. In such implementations of the second example, the first spacer may include a first arced interior boundary. A first wall terminates at a first end that, together with the first arced interior boundary, defines the arcuate section of the first flow path. The second spacer may include a second arced interior boundary. The second wall terminates at a second end that, together with the second arced interior boundary, defines the arcuate section of the second flow path.

In various implementations of the second example, the method includes directing the second fluid in the second flow path across a third surface of a second ion exchange membrane that has a third surface and a fourth, opposite surface. The second spacer contacts the third surface of the second ion exchange membrane. The first linear section of the second flow path directs flow across a first area of the third surface. A second linear section of the second flow path directs flow across a second area of the third surface. The arcuate section of the second flow path directs flow across a second arcuate section of the third surface. The method includes directing a third fluid through a third flow path across a fourth surface of the second ion exchange membrane. The third flow path is defined by interior boundaries formed in the third spacer. The third flow path includes a first linear section that directs flow in the first direction across a first area of the fourth surface. The first area of the fourth surface is coextensive with the first area of the third surface. The third flow path includes a second linear section that directs flow in the second direction across a second area of the fourth surface. The second area of the fourth surface is coextensive with the second area of the third surface. The third flow path includes an arcuate section that directs flow from the first linear section of the third flow path, across a second arcuate section of the fourth surface, to the second linear section of the third flow path. The second arcuate section of the fourth surface being coextensive with the second arcuate section of the third surface. In such implementations of the second example, the plurality of layers may include a third ion exchange membrane that includes a fifth surface. The third spacer contacts the fifth surface of the third ion exchange membrane. The first linear section of the third flow path directs flow across a first area of the fifth surface, the second linear section of the third flow path directs flow across the second area of the fifth surface, and the arcuate section of the third flow path directs flow across a third arcuate section of the fifth surface.

In various implementations of the second example, the first spacer includes interior boundaries that define a first inlet that directs flow to the first flow path and a first outlet that receives flow from the first flow path. The second spacer includes interior boundaries that define a second inlet that directs flow to the second flow path and a second outlet that receives flow from the second flow path. The third spacer includes interior boundaries that define a third inlet that directs flow to the third flow path and a third outlet that receives flow from the third flow path.

In various implementations of the second example, the first flow path and the second flow path are configured to balance pressure across the first ion exchange membrane. The arcuate sections of the first flow path and the second flow path are shaped to prevent dead flow zones in the arcuate sections. The first ion exchange membrane has a thickness of less than or equal to 70 micrometers. The first spacer and the second spacer contact the first ion exchange membrane to form a seal about the first flow path and the second flow path. The first ion exchange membrane includes at least one of an anion exchange membrane, a cation exchange membrane, or a bipolar membrane.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. An electrodialysis stack comprising a plurality of layers disposed between an anode and a cathode, the plurality of layers comprising:
a plurality of ion exchange membranes, the plurality of ion exchange membranes comprising a first ion exchange membrane comprising a first surface and a second, opposite surface;
a plurality of spacers, the plurality of spacers comprising:
a first spacer that contacts the first surface of the first ion exchange membrane and comprises interior boundaries that define a first flow path across the first surface of the first ion exchange membrane, a first inlet that directs flow to the first flow path and a first outlet that receives flow from the first flow path, the first flow path comprising:
a first linear section that directs flow in a first direction across a first area of the first surface;
a second linear section that directs flow in a second, opposite direction across a second area of the first surface; and
an arcuate section that directs flow from the first linear section of the first flow path, across an arcuate section of the first surface, to the second linear section of the first flow path;
a second spacer that contacts the second surface of the first ion exchange membrane and comprises interior boundaries that define a second flow path across the second surface of the first ion exchange membrane, a second inlet that directs flow to the second flow path and a second outlet that receives flow from the second flow path, the second inlet being of the same diameter as the first inlet and the second outlet being of the same diameter as the first outlet, the second flow path comprising:
a first linear section that directs flow in the first direction across a first area of the second surface, the first area of the second surface being coextensive with the first area of the first surface;
a second linear section that directs flow in a second direction across a second area of the second surface, the second area of the second surface being coextensive with the second area of the first surface;
an arcuate section that directs flow from the first linear section of the second flow path, across an arcuate section of the second surface, to the second linear section of the second flow path, the arcuate section of the second surface being coextensive with the arcuate section of the first surface; and
wherein the first flow path and the second flow path are configured to balance pressure across the first ion exchange membrane, such that the first and second flow paths are configured to operate without substantial differential pressure across the first ion exchange membrane during operation.

2. The electrodialysis stack of claim 1, wherein:
the arcuate section of each flow path is a first arcuate section;
the first flow path comprises:
a third linear section that directs flow in the first direction across a third area of the first surface; and
a second arcuate section that directs flow from the second linear section of the first flow path, across a second arcuate section of the first surface, to the third linear section of the first flow path; and
the second flow path comprises:
a third linear section that directs flow in the first direction across a third area of the second surface, the third area of the second surface being coextensive with the third area of the first surface; and
a second arcuate section that directs flow from the second linear section of the second flow path, across a second arcuate section of the second surface, to the third linear section of the second flow path, the second arcuate section of the second surface being coextensive with the second arcuate section of the first surface.

3. The electrodialysis stack of claim 1, wherein:
the first spacer comprises a first wall comprising:
a first side that partially defines the first linear section of the first flow path; and
a second, opposite side that partially defines the second linear section of the first flow path; and
the second spacer comprises a second wall that is coextensive with the first wall, the second wall comprising:
a first side that partially defines the first linear section of the second flow path; and
a second, opposite side that partially defines the second linear section of the second flow path.

4. The electrodialysis stack of claim 3, wherein:
the first spacer comprises a first arced interior boundary, and the first wall terminates at a first end that, together with the first arced interior boundary, defines the arcuate section of the first flow path; and
the second spacer comprises a second arced interior boundary, and the second wall terminates at a second end that, together with the second arced interior boundary, defines the arcuate section of the second flow path.

5. The electrodialysis stack of claim 1, wherein:
the plurality of ion exchange membranes comprises a second ion exchange membrane comprising a third surface and a fourth, opposite surface, wherein the second spacer contacts the third surface of the second ion exchange membrane, the first linear section of the second flow path directs flow across a first area of the third surface, the second linear section of the second flow path directs flow across a second area of the third surface, the arcuate section of the second flow path directs flow across an arcuate section of the third surface;
the plurality of spacers comprises a third spacer that contacts the fourth surface of the second ion exchange membrane and comprises interior boundaries that define a third flow path across the fourth surface of the second ion exchange membrane, the third flow path comprising:
a first linear section that directs flow in the first direction across a first area of the fourth surface, the first area of the third surface being coextensive with the first area of the third surface;
a second linear section that directs flow in the second direction across a second area of the fourth surface, the second area of the fourth surface being coextensive with the second area of the third surface; and
an arcuate section that directs flow from the first linear section of the third flow path, across a second arcuate section of the fourth surface, to the second linear section of the third flow path, the arcuate section of the fourth surface being coextensive with the arcuate section of the third surface.

6. The electrodialysis stack of claim 5, where the plurality of ion exchange membranes comprises a third ion exchange membrane comprising a fifth surface, wherein the third spacer contacts the fifth surface of the third ion exchange membrane, the first linear section of the third flow path directs flow across a first area of the fifth surface, the second linear section of the third flow path directs flow across the second area of the fifth surface, and the arcuate section of the third flow path directs flow across a third arcuate section of the fifth surface.

7. The electrodialysis stack of claim 5, wherein:
the third spacer comprises interior boundaries that define a third inlet that directs flow to the third flow path and a third outlet that receives flow from the third flow path.

8. (canceled)

9. The electrodialysis stack of claim 1, wherein the arcuate sections of the first and second flow paths are shaped to prevent dead flow zones in the arcuate sections.

10. The electrodialysis stack of claim 1, wherein the first ion exchange membrane has a thickness of less than or equal to 70 micrometers.

11. The electrodialysis stack of claim 1, wherein the first and second spacers contact the first ion exchange membrane to form a seal about the first and second flow paths.

12. The electrodialysis stack of claim 1, wherein the first ion exchange membrane comprises a cation exchange membrane, an anion exchange membrane, or a bipolar membrane.

13. An electrodialysis method performed by an electrodialysis stack comprising an ion exchange membrane disposed between a first spacer and a second spacer, the method comprising:
directing a first fluid through a first inlet to a first flow path across a first surface of the ion exchange membrane to a first outlet, the first inlet, the first flow path, and the first outlet defined by interior boundaries of the first spacer, the first flow path comprising:
a first linear section that directs flow in a first direction across a first area of the first surface;
a second linear section that directs flow in a second, opposite direction across a second area of the first surface; and
an arcuate section that directs flow from the first linear section of the first flow path, across an arcuate section of the first surface, to the second linear section of the first flow path;
directing a second fluid through a second inlet to a second flow path across a second, opposite surface of the ion exchange membrane to a second outlet, the second inlet, the second flow path, and the second outlet defined by interior boundaries of the second spacer, the second inlet being of the same diameter as the first inlet and the second outlet being of the same diameter as the first outlet, the second flow path comprising:
a first linear section that directs flow in the first direction across a first area of the second surface, the first area of the second surface being coextensive with the first area of the first surface;
a second linear section that directs flow in the second direction across a second area of the second surface, the second area of the second surface being coextensive with the second area of the first surface; and
an arcuate section that directs flow from the first linear section of the second flow path, across an arcuate section of the second surface, to the second linear section of the second flow path, the arcuate section of the second surface being coextensive with the arcuate section of the first surface,
wherein directing the first fluid through the first flow path and directing the second fluid through the second flow balances pressure across the ion exchange membrane, such that the first and second flow paths operate without substantial differential pressure across the first ion exchange membrane.

14. The method of claim 13, wherein:
the arcuate section of each flow path is a first arcuate section;
the first flow path comprises:
a third linear section that directs flow in the first direction across a third area of the first surface; and
a second arcuate section that directs flow from the second linear section of the first flow path, across a second arcuate section of the first surface, to the third linear section of the first flow path; and
the second flow path comprises:
a third linear section that directs flow in the first direction across a third area of the second surface, the third area of the second surface being coextensive with the third area of the first surface; and
a second arcuate section that directs flow from the second linear section of the second flow path, across a second arcuate section of the second surface, to the third linear section of the second flow path, the second arcuate section of the second surface being coextensive with the second arcuate section of the first surface.

15. The method of claim 13, wherein:
the first spacer comprises a first wall comprising:
a first side that partially defines the first linear section of the first flow path; and
a second, opposite side that partially defines the second linear section of the first flow path; and
the second spacer comprises a second wall that is coextensive with the first wall, the second wall comprising:
a first side that partially defines the first linear section of the second flow path; and
a second, opposite side that partially defines the second linear section of the second flow path.

16. The method of claim 15, wherein:
the first spacer comprises a first arced interior boundary, and the first wall terminates at a first end that, together with the first arced interior boundary, defines the arcuate section of the first flow path; and
the second spacer comprises a second arced interior boundary, and the second wall terminates at a second end that, together with the second arced interior boundary, defines the arcuate section of the second flow path.

17. The method of claim 13, wherein the ion exchange membrane is a first ion exchange membrane, the electrodialysis stack comprises a second ion exchange membrane disposed between the second spacer and a third spacer, and the method comprises:
directing the second fluid through the second flow path across a third surface of a second ion exchange membrane, wherein the second spacer contacts the third surface of the second ion exchange membrane, the first linear section of the second flow path directs flow across a first area of the third surface, the second linear section of the second flow path directs flow across a second area of the third surface, the arcuate section of the second flow path directs flow across an arcuate section of the third surface;
directing a third fluid through a third flow path across a fourth surface of the second ion exchange membrane, the third flow path defined by interior boundaries formed in a third spacer, the third flow path comprising:
a first linear section that directs flow in the first direction across a first area of the fourth surface, the first area of the third surface being coextensive with the first area of the third surface;
a second linear section that directs flow in the second direction across a second area of the fourth surface, the second area of the fourth surface being coextensive with the second area of the third surface; and
an arcuate section that directs flow from the first linear section of the third flow path, across an arcuate section of the fourth surface, to the second linear section of the third flow path, the arcuate section of the fourth surface being coextensive with the arcuate section of the third surface.

18. The method of claim 17, where the electrodialysis stack comprises a third ion exchange membrane comprising a fifth surface, wherein the third spacer contacts the fifth surface of the third ion exchange membrane, the first linear section of the third flow path directs flow across a first area of the fifth surface, the second linear section of the third flow path directs flow across the second area of the fifth surface, the arcuate section of the third flow path directs flow across a third arcuate section of the fifth surface.

19. The method of claim 17, wherein:
the third spacer comprises interior boundaries that define a third inlet that directs flow to the third flow path and a third outlet that receives flow from the third flow path.

20. (canceled)

21. The method of claim 13, wherein the arcuate sections of the first and second flow paths are shaped to prevent dead flow zones in the arcuate sections.

22. The method of claim 13, wherein the ion exchange membrane has a thickness of less than or equal to 70 micrometers.

23. The method of claim 13, wherein the first and second spacers contact the ion exchange membrane to form a seal about the first and second flow paths.

24. The method of claim 13, wherein the ion exchange membrane comprises a cation exchange membrane, an anion exchange membrane, or a bipolar membrane.

25. The electrodialysis stack of claim 1, wherein the plurality of ion exchange membranes do not require a supporting mesh layer to prevent deflection or deformation of the plurality of ion exchange membranes.

26. The method of claim 13, wherein the ion exchange membrane does not require a supporting mesh layer to prevent deflection or deformation of the ion exchange membrane.
